(19) United States
(12) Patent Application Publication
(10) Pub. No.: US 2013/0332493 A1
(43) Pub. Date: Dec. 12, 2013

(54) Method for Management and Distribution of Airport and Navigation Characteristics

(71) Applicants: Jason Dougherty, Newcastle, WA (US); Christopher Snideman, (US)

(72) Inventors: Christopher Snideman, Tahoe City, CA (US); Jason Dougherty, Newcastle, WA (US)

(73) Assignee: Whispertrack, Truckee, CA (US)

(21) Appl. No.: 13/905,795

(22) Filed: May 30, 2013

Related U.S. Application Data
(60) Provisional application No. 61/655,053, filed on Jun. 4, 2012.

(51) Int. Cl. G06F 17/30

(52) U.S. Cl. CPC G06F 17/30292
USPC 707/805

(57) ABSTRACT

The embodiment of the invention is a method for airports, aircraft operators and other persons or entities to create, edit, and manage airport and navigation characteristics and have immediate, near real-time distribution (paper or electronic) of those characteristics to aircraft crews through the use of user interfaces and quality control.

### RELATED U.S. APPLICATION DATA

Provisional application No. 61655053, filed on Jun. 4, 2012

### REFERENCES

US PATENT DOCUMENTS

| | | |
|---|---|---|
| 8,353,012 | January 2013 | Del Real |
| 8,332,136 | December 2012 | Baker, et al. |
| 8,219,318 | July 2012 | Kreft |
| 8,144,937 | March 2012 | Zimmer, et al. |
| 7,873,465 | January 2011 | Geelen, et al. |
| 7,263,518 | August 2007 | Ledingham, et al. |

OTHER PUBLICATIONS
“How Yelp Works”, How Stuff Works
http://computer.howstuffworks.com/internet/social-
networking/networks/yelp.htm

### DRAWING DESCRIPTIONS

FIG. 1: Overview of the method shows how multiple data characteristics are collected from multiple entities and distributed to and by multiple entities.

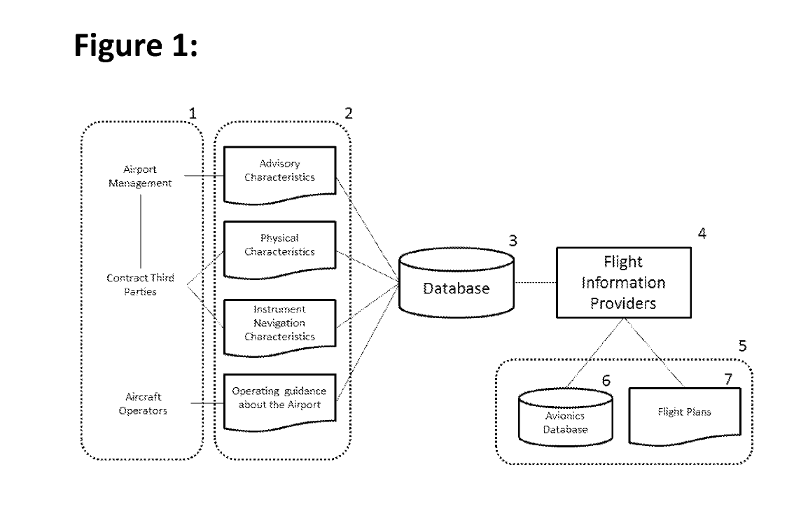

FIG. 2: Overview of the method to create, edit, and distribute airport and navigation characteristics.

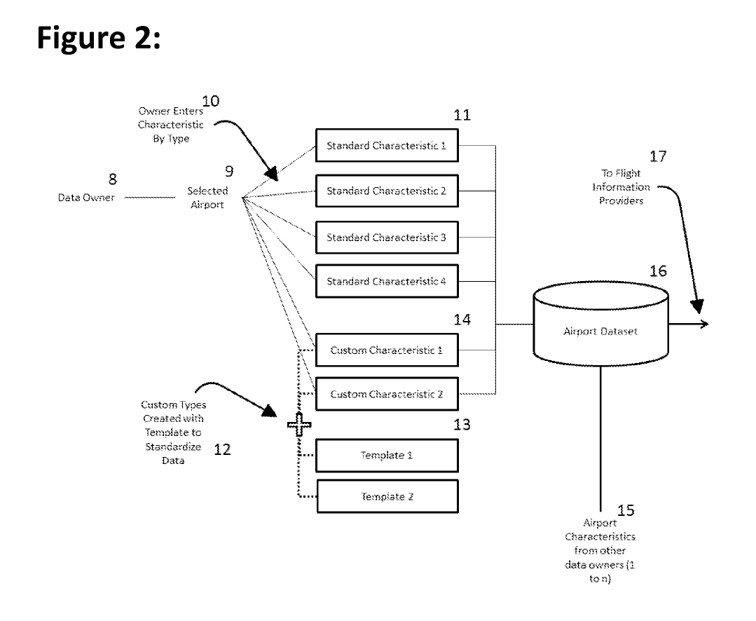

FIG. 3: Sample user interface for entering characteristic(s) and associated metadata.

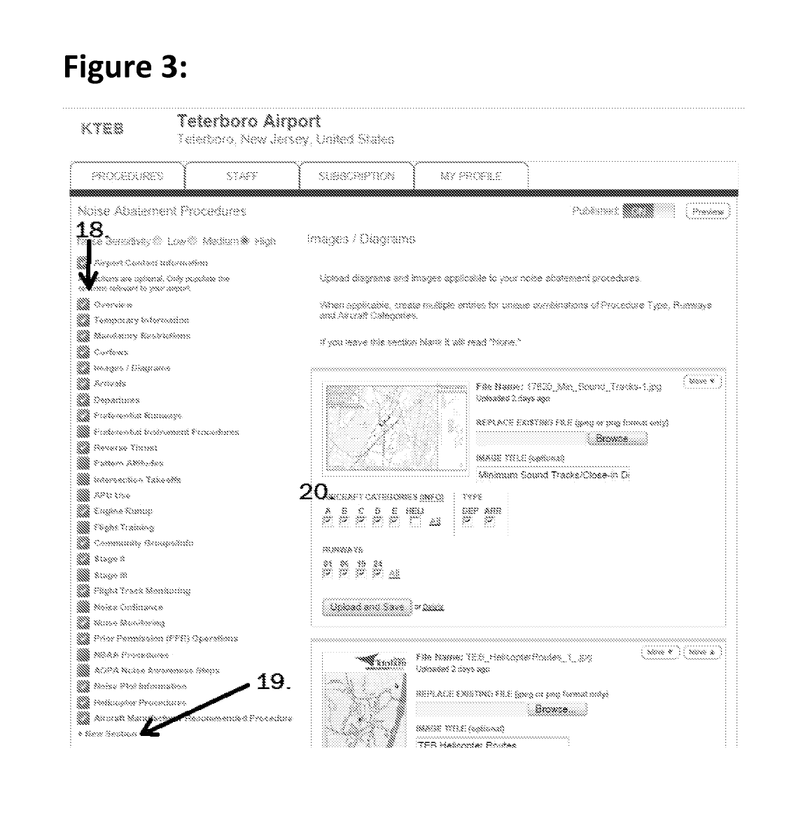

### ABSTRACT

The embodiment of the invention is a method for airports, aircraft operators and other persons or entities to create, edit, and manage airport and navigation characteristics and have immediate, near real-time distribution (paper or electronic) of those characteristics to aircraft crews through the use of user interfaces and quality control.

### BACKGROUND

Airport and navigation characteristics originate from many sources; Airport management, airport contracted 3^{rd} parties, FAA contracted 3^{rd} parties, aircraft operators, and other individuals and entities with local knowledge of the airport, the environment surrounding airports, and the airspace around and between airports. Some airport characteristics are required by law to comply with published data standards. Examples of airport characteristics that have data standards are: runway threshold coordinates, elevations, runway markings, and lighting. Some airport characteristics do not have standards required by law but are equally important for aircraft crew to execute an efficient and safe operation.

Every airport and navigation characteristic that does not have an associated standard results in different conventions employed by each data owner. Flight information services act as the distributors for airport characteristics to aircraft crews. Airport characteristics that are not standardized are prohibitively expensive for flight information service providers to integrate and distribute. This makes these non-standardized characteristics difficult or even impossible for aircraft crew to find and use. For the safe and efficient operation of the aircraft standardized data formats for all navigation and airport characteristics are required.

### INVENTION DESCRIPTION

This invention is a method for creating, updating, and standardizing airport and navigation characteristics and distributing those characteristics to aircraft crews in near real time using a web-based interface and database query at any frequency (on demand or scheduled query consistent with other aviation data cycles, i.e. 56 day navigation data cycle). There are several owners₁ of the characteristics₂ (ex. airport managers, aircraft operators, air traffic control). Each owner can gain access to a web-based user interface where they can create, maintain, and save airport or navigation characteristics to a database₃. Flight Information providers₄ query the standardized characteristics and distribute to aircrews and aircraft operators as part of a complete aviation data package₅ The distribution can be through several possible formats depending on the provider (ex. avionics database, paper charts, faxed flight plans)

To standardize and distribute airport and navigation characteristics each data owner₈ selects an airport₉. Then the data owner selects the characteristic from a provided list defined in the user interface. If the standard is not already defined, the user can create the standard by selecting a template₁₃ defined in the user interface and specifying the metadata that applies to the template (ex. specifying the characteristic as text, image, other).

After the data owner has entered the characteristic(s) they can use the web-based interface to create, edit, and make available to flight information providers the airport or navigation characteristic(s). Each data owner's airport and navigation characteristic(s) are packaged together₁₅ to form a full set of characteristics for the specified airport, the airport dataset₁₆. When flight information providers₁₇ query the database, the airport dataset(s) is/are returned to them. This airport dataset can be packaged with other value added information that the flight information provider has and distributed to aircraft crews and aircraft operators in several formats.

Each airport or navigation characteristic can have several items of metadata₂₀ associated with it. The data owner specifies this metadata and this metadata is used to give aircraft crews and aircraft operators exactly what is needed for a particular flight operation. The aircraft crew can specify the aircraft model, category, registration number, specific usage runway(s), and whether they will be arriving or departing the airport selected. Once specified, these inputs are used to query the database to return only operation-specific information to the flight crew, operator or flight information provider operation.

The invention claimed is:

1. A Method for management and distribution of airport characteristics comprising the steps:
a. Select an airport
b. Create the airport characteristic in a web-based form
c. Save the airport characteristic to a database
d. Pilot information service queries the database for the airport characteristic(s) and downloads the characteristic
e. Flight information providers include airport characteristics in either electronic or paper means to aircraft crews

2. The method of claim 1 where the web-based user interface has built-in standard characteristics that guide the user to standardize the airport characteristics

3. The method of claim 2 where the standard characteristic sections can be text, image, or both.

4. The method of claim 2 where the user can specify the metadata specific to the characteristic they have entered.

5. The method of claim 4 where the metadata includes runway attributes.

6. The method of claim 4 the metadata includes aircraft category attributes.

7. The method of claim 4 where the metadata includes approach or departure operation type attributes.

8. The Method of claim 7 where every airport and navigation characteristic(s) entered by users are compiled to generate an airport dataset.

9. The Method of claim 8 where the airport dataset can be queried by flight information providers, aircraft operators and other navigation specialists and distributed through flight information providers to aircraft crews and aircraft operators in electronic or paper form.

10. The Method of claim 9 where any person can query the database using a web form.

11. A Method for managing airport and navigation characteristics comprising the steps of:
a. Selecting an airport
b. Selecting a predefined standard characteristic of one or more of the following characteristics:
i. Preferential Runways
ii. Pattern Altitude
iii. Arrival
iv. Departure
v. Noise Ordinance
vi. Airport Contact
vii. Preferential Instrument Procedures
viii. Intersection Takeoffs
ix. Engine Runup
x. Flight Training
xi. Community Groups
xii. Flight Track Monitoring
xiii. Temporary Information
xiv. Mandatory Restrictions
xv. Curfews
xvi. Reverse Thrust
xvii. APU Use
xviii. Prior Permission Operations Or,
Creating a custom characteristic using a predefined template
c. Enter text or images in a web-based form consistent with the characteristic(s) selected
d. Save the information to a database

12. The Method of claim 11 where the user can specify the metadata for the characteristic

13. The method of claim 12 where the metadata includes the runway attributes.

14. The method of claim 13 the metadata includes the aircraft category attributes.

15. The method of claim 14 where the metadata includes approach or departure operation attributes.

16. The Method of claim 15 where every user-specified airport or navigation characteristic is compiled to generate an airport dataset.

17. The Method of claim 16 where the airport data set can be queried by flight information providers, aircraft operators and other navigation specialists and distributed through flight information providers to aircraft crews and aircraft operators in electronic or paper form.

18. The Method of claim 17 where any person can query the database using a web form.
